(19) United States
(12) Patent Application Publication
(10) Pub. No.: US 2026/0304307 A1
(43) Pub. Date: Oct. 1, 2026

(54) SYSTEMS AND METHODS FOR RANGE-FINDING CHANNEL CONTROL

(71) Applicant: Zebra Technologies Corporation, Lincolnshire, IL (US)

(72) Inventors: Ohad Shatil, Dunwoody, GA (US); Somesh Agrawal, Westbury, NY (US); Sateesh V. Angadi, Bangalore (IN); Phanindra Kumar Gollapudi, Bangalore (IN); Subramani Rajendiran, Bangalore (IN)

(21) Appl. No.: 19/629,330

(22) Filed: Mar. 26, 2026

(30) Foreign Application Priority Data
Mar. 31, 2025 (IN) 202511031651

(51) Int. Cl. H04W 48/20; H04W 28/02; H04W 48/16; H04W 72/0453; H04W 72/543; H04W 72/566; H04W 76/10

(52) U.S. Cl. CPC H04W 48/20; H04W 28/0226; H04W 48/16; H04W 72/0453; H04W 72/543; H04W 72/569; H04W 76/10

(57) ABSTRACT

A method in a wireless communication device includes: detecting, at the wireless communication device, a first wireless communication channel of a base station; determining whether the first wireless communication channel satisfies a range-finding criterion; when the first wireless communication channel does not satisfy the range-finding criterion, selecting a second wireless communication channel; and performing a range-finding operation with the base station using the second wireless communication channel.

### BACKGROUND

Locationing and/or range-finding by wireless communication devices can rely on various technologies, including measurements of round-trip time for communications with base stations. Certain technologies that use round-trip time measurements for locationing, such as Fine Timing Measurement (FTM), e.g., as implemented in the Institute of Electrical and Electronics Engineers (IEEE) 802.11mc standard, may suffer from reduced accuracy in certain network environments.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a wireless communications system.

FIG. 2 is a diagram of certain internal components of a communications device in the system of FIG. 1.

FIG. 3 is a flowchart of a method of range-finding channel control.

FIG. 4 is a diagram illustrating an example performance of blocks 310 and 315 of the method of FIG. 3.

FIG. 5 is a diagram illustrating an example performance of blocks 310 to 320 of the method of FIG. 3.

FIG. 6 is a diagram illustrating an example repository of configuration parameters for range-finding operations.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a wireless communication device including: detecting, at the wireless communication device, a first wireless communication channel of a base station; determining whether the first wireless communication channel satisfies a range-finding criterion; when the first wireless communication channel does not satisfy the range-finding criterion, selecting a second wireless communication channel; and performing a range-finding operation with the base station using the second wireless communication channel.

Additional examples disclosed herein are directed to a wireless communication device, including: a communication interface; and a controller configured to: detect a first wireless communication channel of a base station; determine whether the first wireless communication channel satisfies a range-finding criterion; when the first wireless communication channel does not satisfy the range-finding criterion, select a second wireless communication channel; and perform a range-finding operation with the base station using the second wireless communication channel.

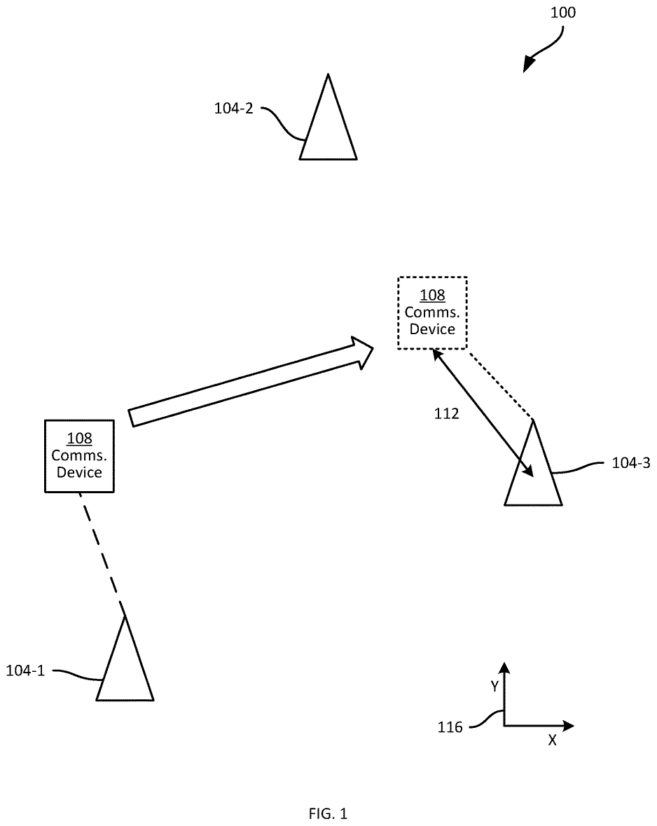

FIG. 1 illustrates a wireless communications system 100, including one or more wireless networks, such as wireless local area networks (WLANs) based on the Institute of Electrical and Electronics Engineers (IEEE) 802.11 family of standards (e.g., one or more Wi-Fi(TM) networks). In other embodiments, the system 100 can include one or more wide-area wireless networks (WWANs), such as cellular networks or the like, in addition to or instead of WLANs. As will be apparent in the discussion below, the functionality implemented in the system 100 can be applied to any of a variety of packet-switched wireless networks, including both local-area and wide-area networks. The system 100 can also include wired networks, e.g., interconnecting one or more of the wireless networks.

In the illustrated example, the system 100 includes a wireless network implemented by at least one base station, such as a wireless access point (AP) in the case of a WLAN. In the discussion below, the network is described as a WLAN, and the base stations are described as APs, but it will be understood that other forms of base station (e.g., gNB base stations in the context of cellular packet-switched networks).

The system 100 includes example access points 104-1, 104-2, and 104-3, which are referred to collectively as the access points 104, and generically as an access point 104. Similar nomenclature may also be used herein for other numbered components with hyphenated suffixes. The system 100 can include more than three access points 104, or fewer than three access points 104, in other examples. The access points 104 can implement a single WLAN, e.g., having a service set identifier SSID). In some examples, the access points 104 can be members of different WLANs (e.g., the APs 104-1 and 104-2 can be members of a given WLAN, and the AP 104-3 can be a member of another WLAN).

Each AP 104 can include an enclosure housing one or more controllers, transceivers, antenna assemblies, and the like. The APs 104 can be connected with a distribution subsystem (DS) or other infrastructure elements connecting the APs 104 to one another and/or to a wide area network.

Wireless communication devices, such as a wireless communication device 108 (also referred to herein as a client device 108), can establish wireless connections the APs 104 in order to communicate with the APs 104 and/or with other devices within the network and/or with other devices outside the network (e.g., via a gateway implemented by suitable network infrastructure). The system 100 can include more than one client device 108 in other examples. The client device(s) 108 of the system 100 can include any one or any suitable combination of mobile computers, smartphones, mobile printers, barcode scanners, tablet computers, or the like.

The client device 108 is mobile, and the physical location of the client device 108 relative to each of the APs 104 can therefore change over time. The client device 108 may, as will be understood by those skilled in the art, roam between the APs 104 as the device 108 moves. For example, in FIG. 1 the client device 108 is shown as being connected to the AP 104-1. The client device 108 may later be moved (e.g., transported by an operator of the device 108) to a different location, indicated in dashed lines in FIG. 1. The device 108 can be configured to assess the quality of the connection with the AP 104-1 and initiate a roaming operation if the connection quality satisfies a roam trigger. The roam trigger can be, for example, a received signal strength indicator (RSSI) corresponding to the AP 104-1 falling below a roaming threshold (e.g., −70 dBm, although a wide variety of other roaming thresholds can also be employed).

In addition, the client device 108 may track its location, e.g., relative to a coordinate system 116 previously defined in a facility containing the APs 104. The client device 108 may implement any suitable one of variety of location-tracking technologies. In some examples, the client device 108 interacts with the APs 104 to implement one or more range-finding operations, based on measurements of round-trip times for communications with the APs 104. Using a range or distance between the client device 108 and each AP 104, along with predetermined positions of the APs 104 in the coordinate system 116, the client device 108 can be configured to trilaterate its own position in the coordinate system 116.

The above range-finding operations can be based, for example, on the Fine Timing Measurement (FTM) protocol implemented in the 802.11mc standard. It will be understood that other range-finding protocols, and/or other implementations of FTM, can also make use of the functionality described herein. The FTM protocol includes exchanging one or more messages between the client device 108 and an AP 104. Based on the timestamps in the messages and the transmission speed of radiofrequency (RF) transmissions through the atmosphere, the client device 108 can determine a distance between itself and the AP 104. The number of messages exchanged during a range-finding interaction, and/or the time separating those messages, and/or the organization of those messages into bursts, can be configured based on environmental or other factors.

The accuracy of a range measurement determined between the client device 108 and an AP 104 may vary according to certain factors. For example, the channel width of the wireless communication channel(s) used to exchange the above-mentioned messages can impact FTM range-finding accuracy. Conducting an FTM operation over a channel with a width of less than 80 MHz, for example, may yield insufficiently accurate range measurements for use in locationing. Many wireless communication channels, however, have channel widths of 20 MHz or 40 MHz. For example, APs 104 operating in the 2.4 GHz Wi-Fi band may implement only channels with widths of 40 MHz or less. APs 104 operating in the 5 GHz and 6 GHz Wi-Fi bands may implement channels with varying widths, including channel widths of 80 MHz, but those APs 104 are often configured to use narrower channels than 80 MHz. Further, APs 104 operating in the 6 GHz Wi-Fi band may, by default, attenuate the signal strength of 6 GHz beacons, e.g., for backwards compatibility with varying types of client devices 108 and/or for breadth of coverage provided by lower frequency bands and narrower channels. In other words, the channels made available to the client device 108 by the APs 104 may often be narrowband (e.g., having channel widths below 80 MHz) and therefore unsuitable for FTM operations.

The client device 108 is therefore configured, as described below, to dynamically assess available channels when initiating an FTM operation, and to interact with the APs 104 to initiate a channel width upgrade, if needed as described further below for the FTM operation. After the FTM operation is complete, and AP 104 and/or the client device 108 can return to any prior-utilized channel. By performing the functionality described herein, the client device 108 can increase the accuracy of range-finding measurements obtained through FTM operations or other functionally equivalent range-finding operations. Further, the functionality described herein, as performed by the client device 108, may provide improved range-finding accuracy while mitigating the potential impact of FTM operations on other network functions, e.g., mitigating impacts on coverage, throughput, and the like.

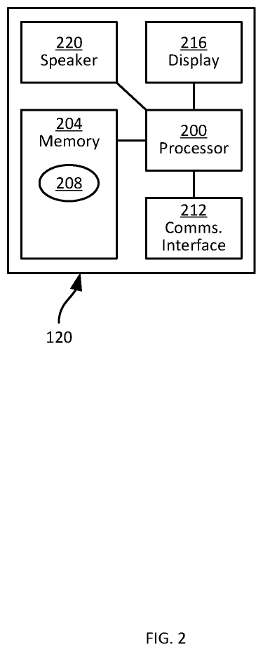

Before describing the dynamic assessment and channel width upgrading functionality implemented by the device 108 in detail, certain internal components of the device 108 are shown in FIG. 2. The device 108 includes a processor 200, such as a central processing unit (CPU), graphics processing unit (GPU), application-specific integrated circuit (ASIC), or the like, communicatively coupled with a non-transitory computer-readable storage medium such as a memory 204, e.g., a combination of volatile memory elements (e.g., random access memory (RAM)) and non-volatile memory elements (e.g., flash memory or the like). The memory 204 stores a plurality of computer-readable instructions in the form of applications, including in the illustrated example a communications application 208, whose execution by the processor 200 configures the device 108 to establish connections with the APs 104, perform roaming operations, implement range-finding operations, e.g., via the FTM protocol, and the like.

The device 108 also includes a communications interface 212, enabling the device 108 to establish connections with networks such as the network implemented by the APs 104. The communications interface 212 can therefore include any suitable combination of transceivers, antenna elements, and corresponding control hardware enabling communications with the APs 104. In some examples, the functionality implemented by the application 208 can be implemented within the communications interface 212, e.g., in the form of firmware instructions or the like stored at the interface 212 and executed by either or both of a dedicated controller of the interface 232 and the processor 200. The processor 200, memory 204, and communications interface 212 can be implemented as components of a system-on-chip (SoC) assembly, in some examples. The device 108 can also include input devices such as a touch screen, a microphone, a camera, or the like, and output devices such as a display 216, a speaker 220, and the like.

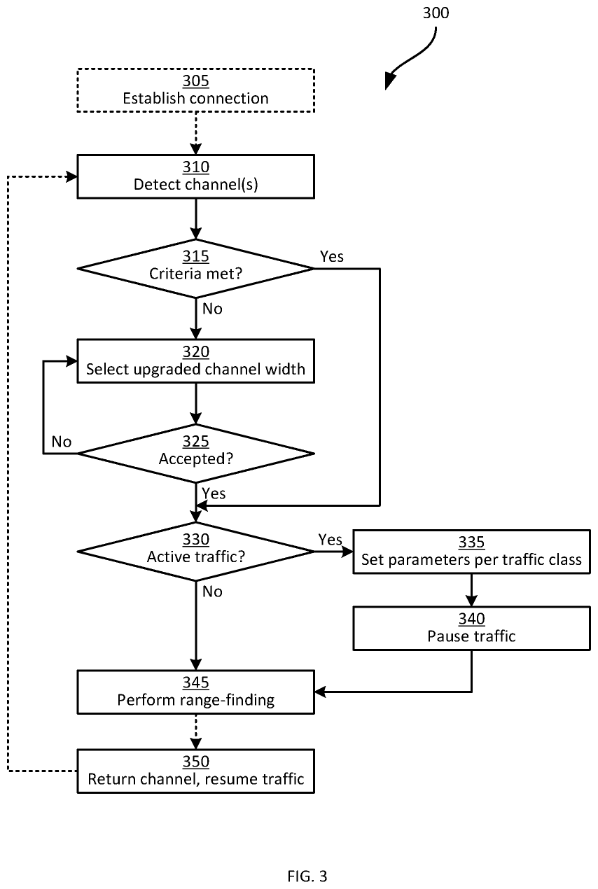

Turning to FIG. 3, a method 300 of range-finding channel assessment and selection (or, more generally, range-finding channel control) is illustrated. The method 300 is described below in conjunction with its performance by the client device 108, for example via the execution of the application 208 by the processor 200 and/or a controller of the communications interface 212.

At block 305, the client device 108 can optionally (as indicated by the use of dashed lines in FIG. 3) establish a connection with an AP 104. The establishment of a connection with an AP 104 is not necessary in order to interact with the AP 104 for range-finding purposes, and therefore in some performances of the method 300, block 305 can be omitted. In some cases, the client device 108 can conduct communications not directly related to range-finding with the AP 104, for which a connection is necessary. For example, the client device 108 can send and/or receive any of a wide variety of data via the AP 104. Examples of such data, also referred to generally as traffic, can include media such as audio and/or video (e.g., for real-time communications such as voice and video calls). The traffic can also include any of a wide variety of other data, e.g., configuration settings for the client device 108, telemetry reported by the client device 108 to a server (not shown), applications data such as e-mail, and the like.

At block 310, the client device 108 is configured to detect available channels, e.g., for use in a range-finding operation. Channel detection need not be explicitly associated with an imminent range-finding operation, however. As will be apparent to those skilled in the art, the client device 108 can periodically perform channel detection for use in a variety of other processes, in addition to range-finding operations. In some examples, channel detection can be performed in response to a local request for a range-finding operation, e.g., from an application other than the application 208 on the client device 108. For example, an enterprise application can configure the client device 108 to report its location in the coordinate system 116 periodically, e.g., to a server or the like. The specific factor or set of factors that lead to initiating a range-finding operation do not directly affect the performance of the range-finding operation via the method 300.

Channel detection at block 310 can include performing a channel scan according to various scanning mechanisms that will occur to those skilled in the art, e.g., to detect beacon frames or the like from one or more APs 104. In some examples, channel detection at block 310 can include receiving a neighbor report from one AP 104 that contains information corresponding to additional APs 104. In further examples, channel detection at block 310 can include retrieving information about one more APs 104 from a cache at the client device 108. The information obtained at block 310 includes a frequency band used by the AP 104, a channel identifier, and a channel width. Such information can also be obtained from probe frames, probe response frames, and the like, from the APs 104. That is, the channel(s) detected at block 310 are those that are available substantially in real-time for the client device 108 to use for a range-finding operation. When the client device 108 is already connected with a given AP 104, e.g., having previously established a connection at block 305, the channels detected at block 310 include the channel on which the client device 108 is currently connected with that AP 104.

The performance of block 310, in other words, yields one or more candidate channels, among which the client device 108 may select to initiate a range-finding operation. The client device 108 can be configured to discard any channels with a signal strength indicator (e.g., a received signal strength indicator (RSSI), expressed in dBm or any other suitable metric) below a threshold, such that those channels are not considered in the remainder of the method 300. At block 315, the client device 108 is configured to determine whether any of the channel(s) detected at block 310 satisfy at least one range-finding criterion. The client device 108 can maintain, e.g., in the form of configuration settings in the application 208 or the like, various criteria for assessing the suitability of various channels for range-finding operations such as FTM. The criteria can include, for example, a predetermined channel width threshold, e.g., indicating a minimum channel width suitable for FTM. For example, the predetermined channel width threshold can be set at 80 MHz. In still further examples, the criteria evaluated at block 315 can include a frequency band criterion. For example, the client device 108 can be configured to determine whether a given channel detected at block 310 is in a preferred band (e.g., the 6 GHz band). The frequency band criterion can also include a ranking of frequency bands in some examples, e.g., indicating that the 6 GHz band is preferred, followed by the 5 GHz band.

The above criteria can be implemented hierarchically. For example, at block 315 the client device 108 can evaluate whether any of the detected channels from block 310 meet the channel width threshold. If at least one of the channels meet the channel width threshold, the client device 108 can then be configured to determine whether any channels in the subset of those meeting the channel width threshold also use the preferred frequency band. When no channels from block 310 meet the channel width threshold, the determination at block 315 is negative. When at least one channel from block 310 meets the channel width threshold, the determination at block 315 is affirmative, and which channel is selected for use in the range-finding operation can depend on the above-mentioned frequency band ranking.

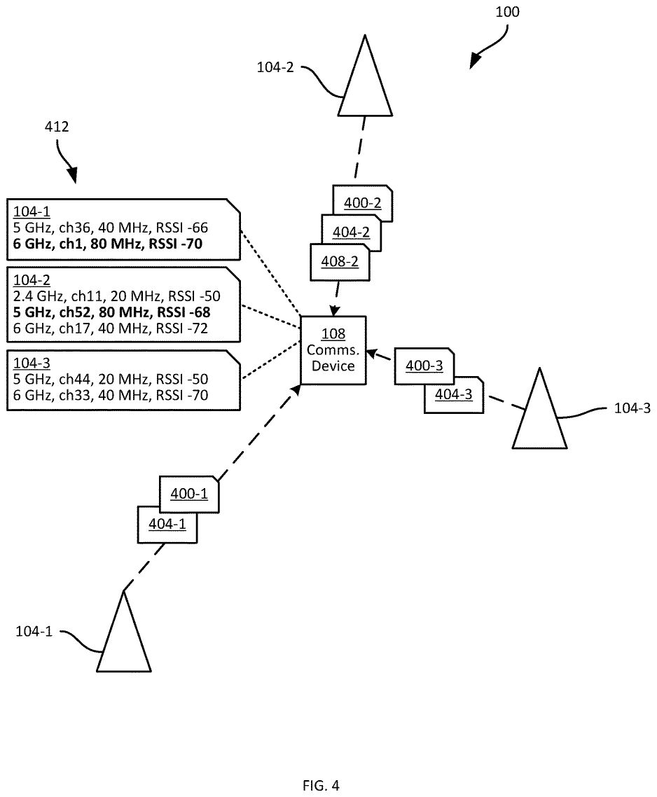

Turning to FIG. 4, an example performance of block 310 is illustrated. The client device 108 can, for example receive beacons from the APs 104-1, 104-2, and 104-3. For example, the APs 104-1, 104-2, and 104-3 can broadcast beacons 400-1, 400-2, and 400-3 respectively (in the 5 GHz band), and beacons 404-1, 404-2, and 404-3 respectively (in the 6 GHz band). The AP 104-2 can additional broadcast a beacon 408-2 in the 2.4 GHz band. As will be apparent, in other examples the AP 104-2 can be, like the APs 104-1 and 104-3, a dual-band AP. In further examples, either or both of the APs 104-1 and 104-3 can be tri-band APs.

From the beacons 400, 404, and 408, the client device 108 determines channel data 412 for each AP 104. The channel data 412 indicates which channels are available from each AP 104, as well as which frequency bands the available channels are in, and the corresponding channel widths. Signal strength indicators are also shown in the channel data 412, and it is assumed that each of the channels represented in the channel data 412 satisfy the above-mentioned signal strength threshold. At block 315, the client device 108 determines whether any of the channels detected at block 310 satisfy the channel width threshold, e.g., of 80 MHz. As shown in FIG. 4, two channels (shown in bold in the diagram) satisfy the channel width threshold. The client device 108 is then configured to select one of those two channels based on the frequency band preference and/or ranking. For example, if the 6 GHz band is the highest-ranked band in the selection criteria, the client device 108 is configured to select the channel identified as “ch1” operated by the AP 104-1 in the 6 GHz band. The determination at block 315 is therefore affirmative.

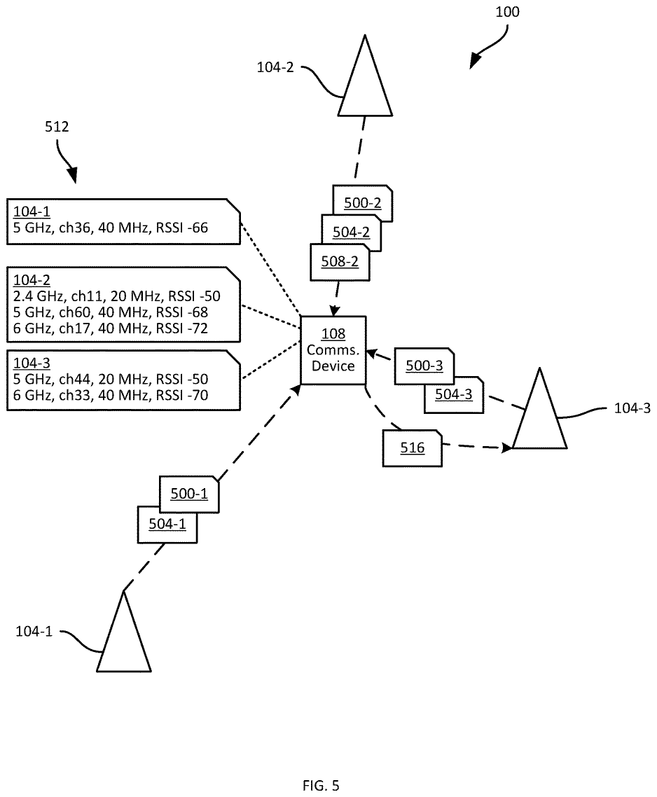

Returning to FIG. 3, when the determination at block 315 is affirmative, the client device 108 can bypass the functionality set out below in connection with blocks 320 and 325, and proceeding directly to block 330, as discussed below. When the determination at block 315 is negative, indicating that none of the channels detected at block 310 satisfy the selection criteria, the client device 108 proceeds to block 320. For example, referring to FIG. 5, another example channel detection process is illustrated. In this example, the APs 104 broadcast beacons 500, 504, and 508, which as as described above in connection with the beacons 400, 404, and 408. A beacon 504-1 of the AP 104-1 has a signal strength below the previously mentioned threshold, and is therefore discarded from channel data 512 at the client device 108. Further, the AP 104-2 deploys a different channel in the 5 GHz band than shown in FIG. 4. That channel, “ch60”, has a channel width of 40 MHz, which does not meet the channel width threshold. Therefore, no channels satisfy the range-finding criteria, and the determination at block 315 is negative. The client device 108 therefore proceeds to block 320.

At block 320, the client device 108 is configured to select an upgraded wireless communication channel width, distinct from the channel widths indicated in the channel data 512. Selecting an upgraded channel width at block 320 can include determining a maximum supported channel width for the client device 108 itself. For example, the client device 108 can include configuration data indicating a maximum supported channel width of the interface 212. The local maximum supported channel width can be dependent on a driver version of the interface 212, for example.

Having determined the supported capabilities of the client device 108, the client device 108 is configured to select an upgraded channel width, e.g., having the maximum supported channel width common to the AP 104 and the client device 108. The client device 108 can be configured to select a frequency band from the channel data 512 according to the previously mentioned frequency band preference or ranking, e.g., the 6 GHz band. When more than one AP 104 supports a preferred frequency band, the client device 108 can select which AP 104 to interact with for upgraded channel width selection based on, for example, signal strength indicators (e.g., selecting the AP 104 from which the strongest beacon was detected). The client device 108 is then configured to transmit a range-finding request to the selected AP 104 that indicates the selected channel width. For example, as shown in FIG. 5, the client device 108 can send a request 516 to the AP 104-3 to initiate a range-finding operation using the 6 GHz band with a channel width of 80 MHz (assuming that is the maximum supported channel width at the client device 108).

Referring again to FIG. 3, at block 325 the client device 108 is configured to determine whether the requested channel or configuration parameters (e.g., a frequency band and a channel width) selected at block 320 have been accepted by the AP 104. As will be apparent to those skilled in the art, the AP 104-3, in response to the request 516, selects a channel for the range-finding operation and informs the client device 108 of that channel. If the channel indicated by the AP 104-3 does not meet the range-finding criteria, the determination at block 325 is negative. In some examples, the AP 104-3 may respond with a channel that does not have the attributes requested, but does satisfy the channel width threshold. In that case, the determination at block 325 is still affirmative. When the determination at block 325 is negative, the client device 108 can be configured to select a further channel at block 320, e.g., suppressing the channel selected in the initial performance of block 320. Blocks 320 and 325 can be repeated until a channel is selected that the client device 108 and AP 104 accept.

At block 330, having selected an upgraded channel width for use in FTM, the client device 108 is configured to determine whether the client device 108 has any active traffic sessions, whether with the AP 104 with which the FTM operation is to be performed, or with another AP 104. When the determination at block 330 is negative, the client device 108 proceeds to block 345 and performs the range-finding operation, e.g., initiating one or more exchanges of timestamped frames, as will be apparent to those skilled in the art. When the determination at block 330 is negative, the client device 108 proceeds to block 335.

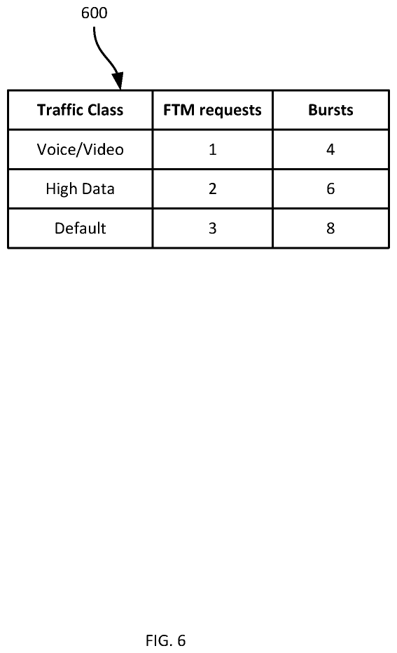

At block 335, the client device 108 is configured to select range-finding control parameters based on a classification of the active traffic. A variety of mechanisms will occur to those skilled in the art for traffic classification, including those based on port numbers and/or protocols (e.g., traffic using the real-time transport protocol or RTP may be classified as voice/video traffic). Other example classification mechanisms may include deep packet inspection, and/or statistical analysis of packet sizes, rates, and the like. As shown in FIG. 6, the client device 108 can store a repository 600 of range-finding parameters, e.g., in a look-up table or the like. The repository 600 can include, for example, parameters corresponding to each of voice or video traffic (e.g., real-time media), high-data rate traffic such as large file transfers or the like, and any traffic that does not classify as the above two classes (“default”). The repository 600 in the illustrated example specifies a number of range-finding requests and a number of bursts (e.g., each containing a number of frames) for each FTM request, for each traffic class. The repository 600 can contain other configurable parameters used in the FTM protocol.

In some examples, the client device 108 may have more than one class of active traffic simultaneously. In such examples, the client device 108 can be configured to select the highest applicable traffic class. That is, the traffic classes can be ranked in the repository 600, e.g., with the first traffic class listed taking precedence over any others that are active.

Having determined a traffic classification and retrieved corresponding parameters from the repository 600, the client device 108 is configured to pause the active traffic session(s) at block 340, e.g., caching any locally-generated packets, and transmitting a request to the relevant AP 104 to cache incoming packets for a predetermined length of time. At block 345, the client device 108 is then configured to perform the range-finding operation according to the parameters set at block 335.

Following performance of the range-finding operation at block 345, the client device 108 can return to a previously connected channel (with the same AP 104 with which the range-finding operation was performed, or with another AP 104). The client device 108 can also resume any traffic paused at block 340. In some examples, if the client device 108 is to perform more than one range-finding operation, e.g., with a plurality of APs 104 to trilaterate a location of the client device 108, the client device 108 can wait for a predetermined time period, e.g., to clear the above-mentioned cache of paused traffic before returning to block 310 for the next range-finding operation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a wireless communication device, the method comprising:
detecting, at the wireless communication device, a first wireless communication channel of a base station;
determining whether the first wireless communication channel satisfies a range-finding criterion;
when the first wireless communication channel does not satisfy the range-finding criterion, selecting a second wireless communication channel; and
performing a range-finding operation with the base station using the second wireless communication channel.

2. The method of claim 1, wherein the range-finding criterion comprises a channel width threshold.

3. The method of claim 2, wherein the range-finding criterion further comprises a predetermined frequency band.

4. The method of claim 1, further comprising:
when the first wireless communication channel satisfies the range-finding criterion, initiating the range-finding operation using the first wireless communication channel.

5. The method of claim 1, further comprising, prior to initiating the range-finding operation:
sending a request to the base station, the request identifying the second wireless communication channel; and
receiving a response from the base station accepting use of the second wireless communication channel for the range-finding operation.

6. The method of claim 1, further comprising:
prior to determining whether the first wireless communication channel satisfies the range-finding criterion, establishing a connection with the base station;
processing communications traffic over the connection; and
prior to performing the range-finding operation, selecting configuration parameters for the range-finding operation based on the communications traffic.

7. The method of claim 6, wherein selecting the configuration parameters comprises:
determining a classification for the traffic; and
retrieving configuration parameters corresponding to the classification.

8. The method of claim 6, further comprising:
pausing transmission of traffic data in response to selecting the second wireless communications channel.

9. A wireless communication device, comprising:
a communication interface; and
a controller configured to:
detect a first wireless communication channel of a base station;
determine whether the first wireless communication channel satisfies a range-finding criterion;
when the first wireless communication channel does not satisfy the range-finding criterion, select a second wireless communication channel; and
perform a range-finding operation with the base station using the second wireless communication channel.

10. The wireless communication device of claim 9, wherein the range-finding criterion comprises a channel width threshold.

11. The wireless communication device of claim 10, wherein the range-finding criterion further comprises a predetermined frequency band.

12. The wireless communication device of claim 9, wherein the controller is further configured to:
when the first wireless communication channel satisfies the range-finding criterion, initiating the range-finding operation using the first wireless communication channel.

13. The wireless communication device of claim 9, wherein the controller is further configured, prior to initiating the range-finding operation, to:
send a request to the base station, the request identifying the second wireless communication channel; and
receive a response from the base station accepting use of the second wireless communication channel for the range-finding operation.

14. The wireless communication device of claim 9, wherein the controller is further configured to:
prior to determining whether the first wireless communication channel satisfies the range-finding criterion, establish a connection with the base station;
process communications traffic over the connection; and
prior to performing the range-finding operation, select configuration parameters for the range-finding operation based on the communications traffic.

15. The wireless communication device of claim 14, wherein the controller is further configured to select the configuration parameters by:
determine a classification for the traffic; and
retrieve configuration parameters corresponding to the classification.

16. The wireless communication device of claim 14, wherein the controller is further configured to:
pause transmission of traffic data in response to selecting the second wireless communications channel.
